(19) United States
(12) Patent Application Publication
(10) Pub. No.: US 2020/0311350 A1
(43) Pub. Date: Oct. 1, 2020

(54) GENERATING METHOD, LEARNING METHOD, GENERATING APPARATUS, AND NON-TRANSITORY COMPUTER-READABLE STORAGE MEDIUM FOR STORING GENERATING PROGRAM

(71) Applicant: FUJITSU LIMITED, Kawasaki-shi (JP)

(72) Inventor: Takuya Makino, Kawasaki (JP)

(73) Assignee: FUJITSU LIMITED, Kawasaki-shi (JP)

(21) Appl. No.: 16/830,364

(22) Filed: Mar. 26, 2020

(30) Foreign Application Priority Data
Mar. 29, 2019 (JP) 2019-068553

(51) Int. Cl. G06F 40/30; G06F 17/18; G06N 3/04; G06N 3/08; G06F 40/295; G06F 40/242

(52) U.S. Cl. CPC G06F 40/30; G06F 17/18; G06F 40/242; G06N 3/08; G06F 40/295; G06N 3/0445

(57) ABSTRACT

A generating method includes: obtaining input text; calculating, for each encoder time corresponding to a word string in the input text, a hidden state at the encoder time from a hidden state at one previous encoder time based on a word in the input text and a label of a named entity corresponding to the encoder time; executing an input processing that includes inputting the hidden state output from the encoder to a decoder; calculating, for each decoder time corresponding to the word string in a summary output from the decoder, a hidden state at the decoder time from a hidden state at one previous decoder time based on the word and label of the named entity in the summary generated at the one previous decoder time.

### CROSS-REFERENCE TO RELATED APPLICATION

This application is based upon and claims the benefit of priority of the prior Japanese Patent Application No. 2019-68553, filed on Mar. 29, 2019, the entire contents of which are incorporated herein by reference.

### FIELD

The embodiments discussed herein relate to a generating method, a learning method, a generating apparatus, and a non-transitory computer-readable storage medium for storing a generating program.

### BACKGROUND

Machine learning such as a neural network may be used for automatic summarization that generates a summary from a document on newspaper, a web site, an electric bulletin board or the like. For generation of a summary, a model is used that is constructed by coupling a recurrent neural networks (RNN) encoder that vectorizes input text and an RNN decoder that repeats generation of words of a summary with reference to the vectors of input text, for example.

Additionally, Pointer-Generator has been proposed (Pointer Generator Networks) that may copy a word of input text as a word of a summary when an RNN decoder outputs words in the summary by combining RNN and Pointer functions.

Examples of the related art include Japanese Laid-open Patent Publication No. 2009-48472 and Japanese Laid-open Patent Publication No. 2011-243166.

Examples of the related art include Abigail See, Peter J. Uu, Christopher D. Manning “Get To The Point: Summarization with Pointer-Generator Networks” ACL 2017.

### SUMMARY

According to an aspect of the embodiments, a generating method includes: executing an obtaining processing that includes obtaining input text; executing a first calculating processing that includes calculating, for each encoder time corresponding to a word string in the input text, a hidden state at the encoder time from a hidden state at one previous encoder time based on a word in the input text and a label of a named entity corresponding to the encoder time; executing an input processing that includes inputting the hidden state output from the encoder to a decoder; executing a second calculating processing that includes calculating, for each decoder time corresponding to the word string in a summary output from the decoder, a hidden state at the decoder time from a hidden state at one previous decoder time based on the word and label of the named entity in the summary generated at the one previous decoder time; executing a third calculating processing that includes calculating a first probability distribution based on the hidden state at the decoder time and the hidden state at the encoder time, the first probability distribution being a probability distribution in which each of words in the word string in the input text is to be copied as a word in the summary at the decoder time; executing a fourth calculating processing that includes calculating a second probability distribution based on the hidden state at the decoder time, the second probability distribution being a probability distribution in which each of words in a dictionary of a model including the encoder and the decoder is to be generated as a word in the summary at the decoder time; and executing a generating processing that includes generating words in the summary at the decoder time based on the first probability distribution and the second probability distribution.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating functional configurations of apparatuses included in a system according to Embodiment 1;

FIG. 2 is a diagram illustrating an example of a use case of an article summarization tool;

FIG. 3 is a diagram illustrating an example of model learning;

FIG. 4 is a diagram illustrating an example of summary generation;

FIG. 5 is a diagram illustrating an example of input text;

FIG. 6A is a diagram Illustrating an example of a summary;

FIG. 6B is a diagram illustrating an example of a summary;

FIGS. 7A and 7B is a flowchart illustrating the steps of learning processing according to Embodiment 1;

FIG. 8 is a flowchart illustrating the steps of generation processing according to Embodiment 1; and

FIG. 9 is a diagram illustrating a hardware configuration example of a computer.

### DESCRIPTION OF EMBODIMENT(S)

However, it is still difficult for the technology above to include an unknown word in a proper expression in a summary.

As an example, one failure case with a combination of Pointer-Generator will be described. For example, when an unknown word such as a phrase “Xxxxxx.com” is included in input text, “.” of the phrase of the unknown word may be copied as a word of the resulting summary. As a result of the copy of a word in the middle of the phrase of an unknown word in input text, a summary may be generated that is unnatural to humans.

According to one aspect, it is an object of the embodiments to provide a generating method, a learning method, a generating program and a generating apparatus, which may include an unknown word in a proper expression in a summary.

An unknown word may be included in a proper expression in a summary.

With reference to the attached drawings, a generating method, learning method, a generating program and a generating apparatus according to the subject application will be described below. It is not intended that the technology disclosed here is limited by embodiments. It is possible to combine embodiments appropriately as long as the processing details do not conflict.

### Embodiment 1

[System Configuration]

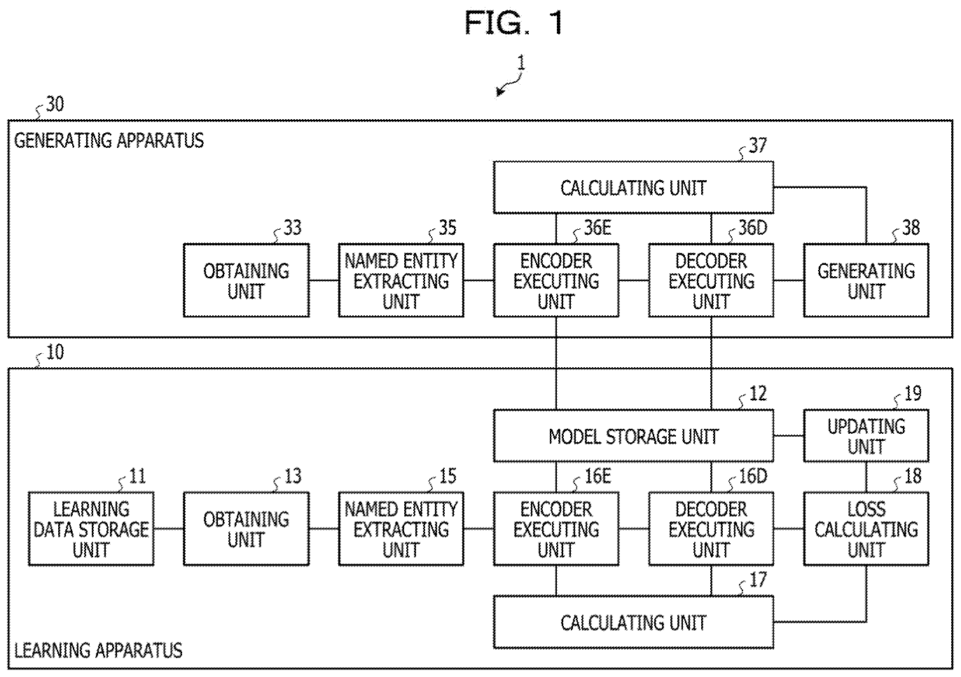

FIG. 1 is a block diagram illustrating functional configurations of apparatuses included in a system according to Embodiment 1. A system 1 illustrated in FIG. 1 provides a machine learning service that performs machine learning on a model by using learning data including input text for learning and correct answer summaries and a summary generation service that generates a summary from input text by using the trained model.

As illustrated in FIG. 1, the system 1 may include a learning apparatus 10 and a generating apparatus 30. By receiving a model having learned in the learning apparatus 10, the generating apparatus 30 generates a summary corresponding to given input text.

The learning apparatus 10 corresponds to an example of a computer that provides the machine learning service. In a case where the learning apparatus 10 and the generating apparatus 30 are deployed in different computers, the model is passed through network communication.

According to an embodiment, the learning apparatus 10 may be implemented by installing, to a desired computer, a learning program configured to achieve the machine learning service as package software or online software. The thus installed learning program is executed by a computer so that the computer may function as the learning apparatus 10.

As an example, the learning apparatus 10 may be implemented as a server apparatus that accommodates the generating apparatus 30 as a client and that provides the machine learning service to the client. In this case, the learning apparatus 10 may be implemented as a server configured to provide the machine learning service on premise or may be implemented as a cloud configured to provide the machine learning service by outsourcing.

For example, the learning apparatus 10 receives input of learning data including a plurality of learning samples or identification information with which learning data may be invoked over network communication or through a storage medium and outputs a learning result of the model to the generating apparatus 30. In this case, as an example, the learning apparatus 10 may provide parameters of the model of a neural network to which an RNN encoder and an RNN decoder are coupled. In addition, the learning apparatus 10 may provide an application program functionally including summary generation implemented by using a trained model. For example, the learning apparatus 10 may provide an application program that generates, as a summary, an article title from original text of an article in newspaper, an electric bulletin board, a web site or the like or generates a prompt report from original text of such an article as a summary.

The forms of provision of the machine learning service are examples, and the machine learning service may be provided in provision forms other than the examples described above. For example, the learning program itself that implements the machine learning service may be provided as package software or online software, or a computer incorporating the learning program may be provided.

The generating apparatus 30 corresponds to an example of a computer that provides the summary generation service.

According to an embodiment, the generating apparatus 30 may be implemented by installing, to a desired computer, a generating program configured to achieve the summary generation service as package software or online software. The thus installed generating program is executed by a computer so that the computer may function as the generating apparatus 30.

As an example, the summary generation service may be provided as one such as “article summarization tool” of tools of web services provided for media operators who run media such as newspaper, an electric bulletin board, and a web site. In this case, frontend functions such as input of original text and display of a summary among functions provided as the web services may be implemented in a terminal apparatus of a journalist, an editor or the like, and backend functions such as generation of a summary may be implemented in the generating apparatus 30.

[Example of Use Case of Article Summarization Tool]

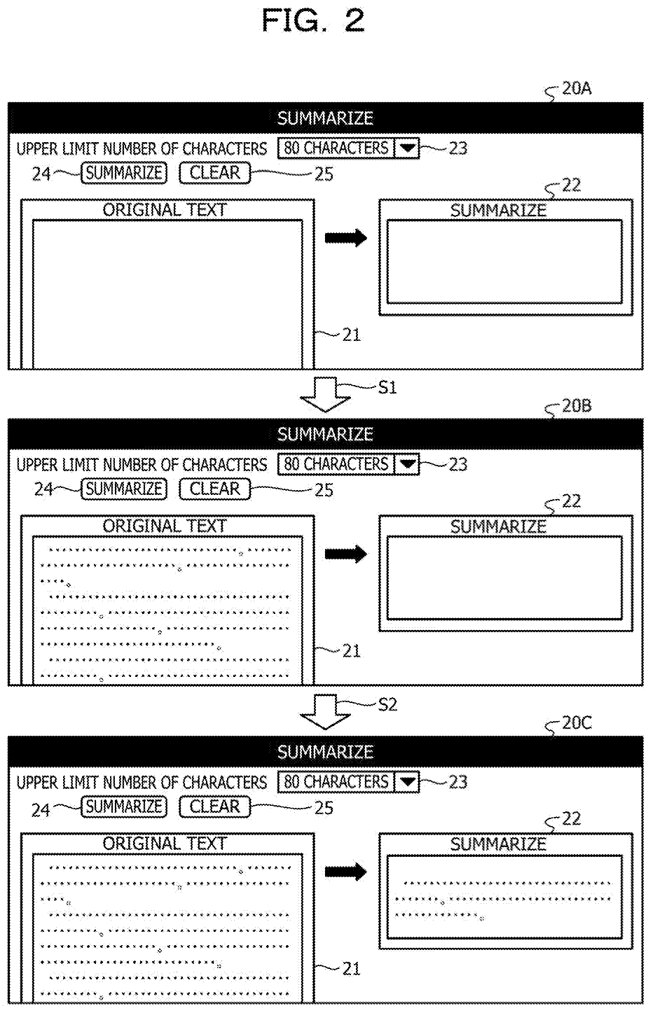

FIG. 2 is a diagram illustrating an example of a use case of an article summarization tool. FIG. 2 illustrates an example of transitions of an article summarization screen 20 displayed on a terminal apparatus used by a person associated with a media operator.

An article summarization screen 20A illustrated in FIG. 2 is an example of a screen displayed at an initial state without any input set for items. For example, the article summarization screen 20A includes graphical user interface (GUI) components such as an original text input area 21, a summary display area 22, a pull-down menu 23, a summarization button 24, and a clear button 25. Among them, the original text input area 21 corresponds to an area in which original text such as an article is to be input. The summary display area 22 corresponds to an area that displays a summary corresponding to the original text input to the original text input area 21. The pull-down menu 23 corresponds to an example of a GUI component with which the upper limit number of characters of the summary is designated. The summarization button 24 corresponds to an example of a GUI component that receives execution of a command for generating a summary corresponding to original text input to the original text input area 21. The clear button 25 corresponds to an example of a GUI component that clears the original text input to the original text input area 21.

As illustrated in FIG. 2, in the original text input area 21 on the article summarization screen 20A, input of text may be received through an input device such as a keyboard, not illustrated. Text may be imported from a file of a document generated by an application such as word processor software to the original text input area 21, in addition to reception of input of text through an input device.

In response to such input of original text to the original text input area 21, the display of the terminal apparatus is shifted from the article summarization screen 20A to an article summarization screen 20B (step S1). For example, when original text is input to the original text input area 21, execution of a command that generates a summary may be received through an operation performed on the summarization button 24. The text input to the original text input area 21 may be cleared through an operation performed on the clear button 25. In addition, through the pull-down menu 23, designation of the upper limit number of characters desired by a person associated with a media operator from a plurality of upper limit numbers of characters may be received. FIG. 2 illustrates an example in which 80 characters corresponding to an example of the upper limit number of characters displayable on an electric bulletin board is designated as an example of a scene where a prompt report to be displayed on the electric bulletin board is generated as a summary from original text of an article in a newspaper or news. This is given for illustration purpose, and the upper limit number of characters corresponding to a title may be selected in a case where the title is generated from an article in a newspaper or a website. In addition, the upper limit of the number of characters may not be specified.

When an operation is performed on the summarization button 24 in the state that the original text input area 21 has original text, the display of the terminal apparatus is shifted from the article summarization screen 20B to an article summarization screen 20C (step S2). In this case, the original text Input to the original text input area 21 is input to the trained model as input text to generate its summary. This summary generation may be executed over a terminal apparatus of a person who is associated with a media operator or may be executed over a backend server apparatus. After a summary is generated in this manner, the summary display area 22 over the article summarization screen 20C displays the summary generated by the trained model.

The text of the summary displayed in the summary display area 22 over the article summarization screen 20C may be edited through an input device, for example, not Illustrated.

The provision of the article summarization tool allows reduction of article summarization works performed by a journalist, an editor or the like. For example, from one point of view, article summarization works require relatively large labor in a process for distributing news to media including “selection of an article to be distributed”, “transmission to a media editing system”, “article summarization”, “title generation” and “proofreading”. For example, in a case where the article summarization is performed by a human, works are required including selecting important information from a whole article and reconstructing sentences. Therefore, the technical meaning of automation or semi-automation of such article summarization works is significant.

Having described the use case in which the article summarization tool is used by a person associated with a media operator, for example, the article summarization tool may be used by a reader who receives distribution of an article from the media operator. For example, through a smart speaker or the like, the article summarization tool may be used as a function that reads aloud a summary of an article instead of a function that reads aloud whole text.

Having described that the generating apparatus 30 is implemented as a computer that provides the summary generation service as an example, embodiments are not limited thereto. For example, a generating program incorporating the trained model may be implemented as a standalone application program executed in an arbitrary computer such as a terminal apparatus of a journalist, an editor or the like.

Having described the example in which the machine learning service and the summary generation service are executed by different business entities, these two services may be provided by one business entity. In this case, the learning program and the summary generating program may be executed by one computer or computer system.

[Pointer-Generator]

In the learning apparatus 10 and the generating apparatus 30, Pointer-Generator is applied. When an RNN decoder outputs words of a summary, the Pointer-Generator may copy a word of input text as a word of the summary.

[One Aspect of Problem]

As described in the section BACKGROUND, it is still difficult for Pointer-Generator to include an unknown word in a proper expression in a summary.

For example, a failure case may occur in which, when an unknown word such as a phrase “Xxxxxx.com” is included in input text, “.” of the phrase of the unknown word may be copied as a word of the resulting summary. As a result of the copy of a word in the middle of the phrase of an unknown word in Input text, a summary may be generated that is unnatural to humans.

[One Aspect of Approach for Problem Solution]

Accordingly, in this embodiment, a hidden state repeatedly updated with words of input text and labels of named entities is input to a decoder, and the decoder updates the hidden state with a word one time ago and labels of named entities, calculates an attention distribution and a vocabulary distribution, and outputs words of a summary.

The term “attention distribution” refers to a probability distribution acquired by calculating, for each word included in input text, a probability for copying the word as a word in a summary. The term “vocabulary distribution” refers to a probability distribution acquired by calculating, for each word included in a dictionary of a model, a probability for generating the word as a word in a summary.

For calculation of the attention distribution and the vocabulary distribution, a hidden state is used that is acquired by repeatedly performing updates each adding a word one time ago and a label of a named entity for each time corresponding to a word string of a summary to be output by the decoder.

For example, a label such as B-XXX or I-XXX is exemplarily given to a word that is a named entity while a label such as “OTHER” is given to a word that is not a named entity. A category of the named entity such as “COUNTRY” or “ORGANIZATION” is written in the part XXX.

The use of the hidden state including a vector of an NE label for calculation of an attention distribution and a vocabulary distribution increases the possibility for avoiding a failure in the failure copy case with Pointer-Generator in the past. In other words, for example, the situation may be suppressed in which an attention distribution is calculated for extracting only the word “.” that is not the beginning of a named entity of named entity phrase “Xxxxxx.com” and easily copying it as a word of a summary.

There is a high possibility that unknown words not in a dictionary of an RNN model are mostly named entities. In other words, for example, while it is difficult even for a corpus having an enormous number of vocabularies to cover named entities including numerical expressions such as time expressions, quantities, and percentages, it is easier to cover the other words than covering of named entities. Accordingly, it may be predicted that, if named entities included in input text may be copied properly, unknown words included in the input text may be mostly copied.

Therefore, according to this embodiment, unknown words may be included in a proper expression in a summary.

[Configuration of Learning Apparatus 10]

As illustrated in FIG. 1, the learning apparatus 10 includes a learning data storage unit 11, a model storage unit 12, an obtaining unit 13, a named entity extracting unit 15, an encoder executing unit 16E, a decoder executing unit 16D, a calculating unit 17, a loss calculating unit 18, and an updating unit 19. In addition to the functional units illustrated in FIG. 1, the learning apparatus 10 may include various functional units that known computers usually include, such as various input devices and various audio output devices.

The functional units such as the obtaining unit 13, the named entity extracting unit 15, the encoder executing unit 16E, the decoder executing unit 16D, the calculating unit 17, the loss calculating unit 18, and the updating unit 19 illustrated in FIG. 1 are given for illustration purpose and may be implemented virtually by the following hardware processor. Examples of such a processor include a deep learning unit (DLU), general-purpose computing on graphics processing units (GPGPU) and a GPU duster. Examples of the processor further include a central processing unit (CPU) and a microprocessor unit (MPU). In other words, for example, the processor expands the learning program as a process over a memory such as a random-access memory (RAM) to virtually implement the aforementioned functional units. Although the DLU, the GPGPU, the GPU duster, the CPU and the MPU are exemplified as one example of the processor here, the functional units may be implemented by any processor regardless of whether the processor is a general-purpose type or a special type. In addition, the functional units described above may be implemented by a hard wired logic circuit such as an application specific integrated circuit (ASIC) or a field-programmable gate array (FPGA).

The learning data storage unit 11, the model storage unit 12 and the like illustrated in FIG. 1 may be a storage device such as a hard disk drive (HDD), an optical disk or a solid state drive (SSD). The storage device may not be an auxiliary storage device but may be a semiconductor memory element such as a RAM, an EPPROM or a flash memory.

The learning data storage unit 11 is a storage unit that stores learning data. The learning data include 3 learning samples, that is, learning instances, as an example. Each of the learning samples includes a pair of input text and a summary as a correct answer to be used for model learning. Hereinafter, the input text may be called a “learning input text” from a viewpoint that it is used for identifying a label of input text to be input for model learning and for summary generation. This is identification of the labels, and they still correspond to an example of input text. The summary as a correct answer may be called a “correct answer summary” from a viewpoint that it is used for identifying labels of a summary referred as a correct answer and a summary generated from input text for model learning.

The model storage unit 12 is a storage unit that stores information regarding a model.

According to an embodiment, the model storage unit 12 stores a model layer structure such as neurons and synapses of layers including an input layer, a hidden layer and an output layer forming a model of a neural network in which an RNN encoder and an RNN decoder are coupled and model Information including parameters of the model such as weights and biases in the layers. In a stage before model learning is executed, the model storage unit 12 stores parameters initially set with random numbers as an example of the parameters in the model. In a stage after the model learning is executed, the model storage unit 12 stores parameters in the trained model.

The obtaining unit 13 is a processing unit that obtains a learning sample.

According to an embodiment, the obtaining unit 13 starts processing in response to reception of a request for model learning. In this case, the obtaining unit 13 performs initial setting for model learning. For example, the obtaining unit 13 initializes the value of a loop counter j that counts the number of learning samples. Then, the obtaining unit 13 obtains the learning sample corresponding to the value of the loop counter j of J learning samples stored in the learning data storage unit 11. After that, the obtaining unit 13 increments the value of the loop counter j and repeatedly executes processing for obtaining learning samples from the learning data storage unit 11 until the value of the loop counter j is equal to the total number J of the learning samples.

Having described the example in which learning data stored in an internal storage of the learning apparatus 10 is obtained, the information source of the learning data is not limited to the internal storage. For example, learning data may be obtained from an external computer such as a file server or a removable medium. Having described the example that the upper limit number of characters is not specified for a summary to be generated by the model, an upper limit number of characters may be set when a summary is generated.

The named entity extracting unit 15 is a processing unit that extracts a named entity.

According to an embodiment, the named entity extracting unit 15 extracts a named entity from learning input text or a correct answer summary included in learning samples. For example, the named entity extracting unit 15 executes morphological analysis on learning input text or text of a correct answer summary. By using the result of the morphological analysis, the named entity extracting unit 15 executes labeling processing that gives a label relating to a named entity (NE) corresponding to the position of the word for each word included in the learning input text or text in the correct answer summary. Hereinafter, a named entity label may be written as “NE label”. For example, in a word string of input text, a label such as B-XXX or I-XXX is exemplarily given to a word that is a named entity while a label such as “OTHER” is given to a word that is not a named entity. A category of the named entity such as “COUNTRY” or “ORGANIZATION” is written in the part XXX. This labeling processing may use an arbitrary engine for named entity extraction, that may be open-source software.

The encoder executing unit 16E is a processing unit that executes an RNN encoder. The following LSTM is short for a “long short-term memory”.

According to an embodiment, the encoder executing unit 16E expands, over a work area, M LSTM cells corresponding to the number M of words in learning input text based on model information stored in the model storage unit 12. Thus, M LSTM cells are caused to function as an RNN encoder. Hereinafter, encoder times corresponding to word strings in learning input text are time-serially identified as t₁, t₂, t₃, . . . , t_{M}, and an LSTM corresponding to an encoder time tₘ is identified as “LSTM16E-tₘ”.

For example, sequentially from the word at the beginning of learning input text, the encoder executing unit 16E vectorizes the mth word from the beginning of a word string and the NE label given to the word and inputs the vector of the mth word and the vector of the NE label to the LSTM16E-tₘ. The encoder executing unit 16E inputs an output such as a hidden state at the encoder time tₘ₋₁ output from the LSTM16E-tₘ₋₁ to the LSTM16E-tₘ. The LSTM16E-tₘ having received the vector of the mth word, the vector of the NE label and the hidden state at the encoder time tₘ₋₁ adds the vector of the mth word and the vector of the NE label to the hidden state at the encoder time tₘ₋₁ to update the hidden state at the encoder time tₘ₋₁ to a hidden state at the encoder time tₘ. Thus, the update of the hidden states, so-called context vectors are repeated from the LSTM cell corresponding to the word at the beginning of the learning input text to the LSTM cell corresponding to the Mth word at the end. The hidden state of the learning input text thus generated by the RNN encoder is input to the RNN decoder.

The decoder executing unit 16D is a processing unit that executes an RNN decoder.

According to an embodiment, the decoder executing unit 16D expands, over a work area, N LSTM cells corresponding to the number N of words in the correct answer summary based on model information stored in the model storage unit 12. Thus, the N LSTM cells are functioned as an RNN decoder. Hereinafter, decoder times corresponding to word strings in a correct answer summary are time-serially identified as T₁, T₂, T₃, . . . , T_{N}, and an LSTM cell corresponding to a decoder time Tₙ is identified as “LSTM16D-Tₙ”.

First, the decoder executing unit 160 vectorizes a beginning symbol of a word such as <START> and a beginning symbol of an NE label such as <NESTART>. The decoder executing unit 16D inputs the hidden state output from the LSTM16E-t of the RNN encoder along with the vector of the beginning symbol of the word and the vector of the beginning symbol of the NE label to the LSTM16D-T₁ corresponding to the word at the beginning of the correct answer summary. Thus, the LSTM16D-T₁ adds the vector of the beginning symbol of the word and the vector of the beginning symbol of the NE label to the hidden state output from the LSTM16E-t_{M} so that the hidden state at the encoder time t_{M} is updated to the hidden state at the decoder time T₁.

After that, the LSTM16D-T₁ calculates a similarity such as an inner product between the vector of the hidden state at the decoder time T₁ and vectors of the hidden states at the encoder times t₁ to t_{M}. Thus, for each word included in the learning input text, the degree that the word is to be copied as a word in the summary is scored. The LSTM16D-T₁ calculates a similarity such as an inner product between the vector of the hidden state at the decoder time T₁ and a weighting matrix for summary word generation that the RNN decoder has as a parameter of the model. Thus, for each word in the dictionary of the model, the degree that the word is to be generated as a word in the summary is scored. The LSTM16D-T₁ calculates a similarity such as an inner product between the vector of the hidden state at the decoder time T₁ and a weighting matrix for NE label generation that the RNN decoder has as a parameter of the model. Thus, for each category of the NE label, the degree that the category is to be selected at the next decoder time T₂ is scored. The hidden state at the decoder time T₁ updated by the LSTM16D-T₁ is used for calculation of the three scores and is also input to the LSTM16D-T₂.

Also for the subsequent LSTM cells, that is, LSTM16D-T₂ to LSTM16D-T_{N}, the hidden state update and the calculation of the three scores are performed in the same manner as those for LSTM16D-T₁.

In other words, for example, the decoder executing unit 16D vectorizes a word in the correct answer summary at a decoder time Tₙ₋₁ and an NE label at a decoder time Tₙ selected at the decoder time Tₙ₋₁. Along with the vector of the word in the correct answer summary at the decoder time Tₙ₋₁ and the vector of the NE label at the decoder time Tₙ, the decoder executing unit 16D inputs the hidden state at the decoder time Tₙ₋₁, to the LSTM16D-Tₙ. After that, the LSTM16D-Tₙ adds the vector of the word in the correct answer summary at the decoder time Tₙ₋₁ and the vector of the NE label at the decoder time Tₙ to the hidden state at the decoder time Tₙ₋₁. Thus, the hidden state at the decoder time Tₙ₋₁ is updated to the hidden state at the decoder time Tₙ.

After that, the LSTM16D-Tₙ calculates a similarity between the vector of the hidden state at the decoder time Tₙ and vectors of the hidden states at the encoder times t₁ to t_{M}. Thus, for each word included in the learning input text, the degree that the word is to be copied as a word in the summary is scored. The LSTM16D-Tₙ calculates a similarity between the vector of the hidden state at the decoder time Tₙ and a weighting matrix for summary word generation that the RNN decoder has as a parameter of the model. Thus, for each word in the dictionary of the model, the degree that the word is to be generated as a word in the summary is scored. The LSTM16D-Tₙ calculates a similarity between the vector of the hidden state at the decoder time Tₙ and a weighting matrix for NE label generation that the RNN decoder has as a parameter of the model. Thus, for each category of the NE label, the degree that the category is to be selected at the next decoder time Tₙ₊₁ is scored. The hidden state at the decoder time Tₙ updated by the LSTM16D-Tₙ is used for calculation of the three scores and is also Input to the LSTM16D-Tₙ₊₁.

By operating N LSTM cells, scores for words in the learning input text and scores for words in the dictionary of the model are acquired for a set of N LSTM cells.

The calculating unit 17 is a processing unit that calculates a probability distribution.

According to one aspect, when, for each word included in learning input text, the LSTM16D-Tₙ scores the degree that the word is to be copied as a word in a summary, the calculating unit 17 normalizes the score of the word such that the total sum of the scores of the word is equal to “1”. Thus, the copy score of each word in the learning input text is normalized to the copy probability of the word in the learning input text. As a result, an attention distribution at the decoder time Tₙ is acquired.

According to another aspect, when, for each word in the dictionary of the model, the LSTM16D-Tₙ scores the degree that the word is to be generated as a word in a summary, the calculating unit 17 normalizes the score of the word such that the total sum of the scores of the word is equal to “1”. Thus, the generation score of each word in the dictionary of the model is normalized to the generation probability of the word in the dictionary of the model. As a result, a vocabulary distribution at the decoder time Tₙ is acquired.

The thus acquired attention distribution and vocabulary distribution are linearly combined. For example, for a word commonly existing in both of the attention distribution and the vocabulary distribution, the copy probability and the generation probability are added to acquire a composite probability. For a word existing in one distribution of the attention distribution and the vocabulary distribution, the other copy probability or generation probability is defined as zero, and one copy probability or generation probability is added thereto to acquire a composite probability. The composite probabilities of the words are normalized such that the total sum of the composite probabilities of the words in the learning input text and in the dictionary of the model is equal to “1”. Thus, a final distribution at the decoder time Tₙ is acquired.

According to another aspect, when, for each category of an NE label, the LSTM16D-Tₙ scores the degree that the category is to be selected at the decoder time Tₙ₊₁, the calculating unit 17 normalizes scores of the categories such that the total sum of the categories of the NE labels is equal to “1”. Thus, the selection scores of the categories of the NE labels are normalized to selection probabilities of the categories of the NE labels. As a result, an NE category distribution at the decoder time Tₙ₊₁ is acquired.

The loss calculating unit 18 is a processing unit that calculates a loss.

According to an embodiment, when the calculating unit 17 calculates the final distribution at the decoder time Tₙ, the loss calculating unit 18 calculates a first loss between the final distribution at the decoder time Tₙ and the word in the correct answer summary at the decoder time Tₙ. The loss calculating unit 18 calculates a second loss between the NE category distribution at the decoder time Tₙ and an NE label of the word in the correct answer summary at the decoder time Tₙ.

The updating unit 19 is a processing unit that updates parameters in a model.

According to an embodiment, when the loss calculating unit 18 calculates the first loss and the second loss for N LSTM cells in the RNN decoder, the updating unit 19 executes optimization of a log likelihood based on the first loss and the second loss at each of the LSTM cells. Thus, parameters for updating the RNN model are calculated. The updating unit 19 updates the parameters in the model stored in the model storage unit 12 with the parameters acquire by the log-likelihood optimization. This parameter update may be repeatedly executed over all learning samples and may be repeatedly executed over a predetermined number of epochs of learning data J.

[Specific Example of Model Learning]

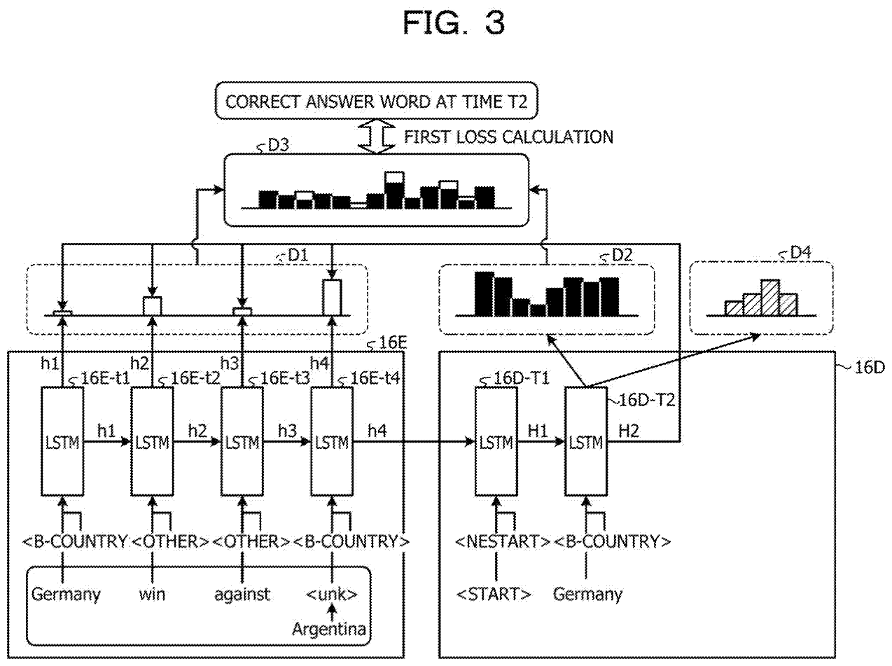

FIG. 3 is a diagram illustrating an example of model learning. FIG. 3 illustrates an example of a case where “Germany win against Argentina” is acquired as an example of learning input text included in a learning sample. FIG. 3 illustrates an example in which “Germany beat Argentina” as an example of a correct answer summary included in the learning sample. In this case, as illustrated in FIG. 3, the encoder executing unit 16E expands, over a work area, four LSTM16E-t₁ to LSTM16E-t₄ corresponding to the number “4” of words of the learning input text.

(1.1) Operations at Encoder Time t₁

The encoder executing unit 16E vectorizes the word “Germany” at the beginning of learning input text and vectorizes the NE label <B-COUNTRY> given to the word “Germany”. Along with the vector of the word “Germany” at the beginning and the vector of the NE label <B-COUNTRY>, the encoder executing unit 16E inputs an initial value h₀ of the vector of a hidden state to the LSTM16E-t₁. The LSTM16E-t₁ adds the vector of the word “Germany” at the beginning and the vector of the NE label <B-COUNTRY> to the vector of the hidden state h₀ being the initial value so that the hidden state h₀ being the initial value is updated to a hidden state h₁ at an encoder time t₁. The updated hidden state h₁ at the encoder time t₁ is input from the LSTM16E-t₁ to an LSTM16E-t₂.

(1.2) Operations at Encoder Time t₂

The encoder executing unit 16E vectorizes the second word “win” from the beginning of the learning input text and vectorizes the NE label <OTHER> given to the word “win”. The encoder executing unit 16E Inputs the vector of the second word “win” and the vector of the NE label <OTHER> to the LSTM16E-t₂. The LSTM16E-t₂ adds the vector of the second word “win” and the vector of the NE label <OTHER> to the vector of the hidden state h₁ at the encoder time t₁ so that the hidden state h₁ at the encoder time t₁ is updated to a hidden state h₂ at an encoder time t₂. The updated hidden state h₂ at the encoder time t₂ is input from the LSTM16E-t₂ to an LSTM16E-t₃.

(1.3) Operations at Encoder Time t₃

The encoder executing unit 16E vectorizes the third word “against” from the beginning of the learning input text and vectorizes the NE label <OTHER> given to the word “against”. The encoder executing unit 16E inputs the vector of the third word “against” and the vector of the NE label <OTHER> to the LSTM16E-t₃. The LSTM16E-t₃ adds the vector of the third word “against” and the vector of the NE label <OTHER> to the vector of the hidden state h₂ at the encoder time t₂ so that the hidden state h₂ at the encoder time t₂ is updated to a hidden state h₃ at an encoder time t₃. The updated hidden state h₃ at the encoder time t₃ is input from the LSTM16E-t₃ to an LSTM16E-t₄.

(1.4) Operations at Encoder Time t₄

Finally, the encoder executing unit 16E vectorizes the fourth word “Argentina” from the beginning of the learning input text and vectorizes the NE label <OTHER> given to the word “Argentina”. The encoder executing unit 16E inputs the vector of the fourth word “Argentina” and the vector of the NE label <OTHER> to the LSTM16E-t₄. The LSTM16E-t₄ adds the vector of the fourth word “Argentina” and the vector of the NE label <OTHER> to the vector of the hidden state h₃ at the encoder time t₃ so that the hidden state h₃ at the encoder time t₃ is updated to a hidden state h₄ at an encoder time t₄. The updated hidden state h₄ at the encoder time t₄ is input from the RNN encoder to the RNN decoder.

In this way, from the LSTM16E-t₁ at the beginning to LSTM16E-t₄ at the end, the hidden state, so-called the context vector is repeatedly updated in order of h₀, h₁, h₂, h₃, and h₄.

(2) Operations at Decoder Time T₁

FIG. 3 illustrates an operation example by the LSTM16D-T₂ at the decoder time T₂. As illustrated in FIG. 3, a hidden state H₁ at the decoder time T₁ that is updated from the hidden state h₄ at the encoder time t₄ by the LSTM16D-T₁ is input to the LSTM16D-T₂. The vector of the word “Germany” in the correct answer summary at the decoder time T₁ and the vector of the NE label <B-COUNTRY> at the decoder time T₂ selected at the decoder time T₁ are input to the LSTM16D-T₂. After that, the LSTM16D-T₂ adds the vector of the word “B-COUNTRY” in the correct answer summary at the decoder time T₁ and the vector of the NE label <B-COUNTRY> at the decoder time T₂ to the hidden state H₁ at the decoder time T₁. Thus, the hidden state H₁ at the decoder time T₁ is updated to a hidden state H₂ at the decoder time T₂.

The LSTM16D-T₂ calculates a similarity between the vector of the hidden state Hz at the decoder time T₂ and vectors of the hidden states h₁ to h₄ at the encoder times t₁ to t₄. Thus, for each word included in the learning input text, the degree that the word is to be copied as a word in the summary is scored. The calculating unit 17 then normalizes the scores of each word in the learning input text such that the total sum of the scores of the words is equal to “1”. Thus, the copy score of each word in the learning input text is normalized to the copy probability. As a result, an attention distribution D1 at the decoder time T₂ is acquired.

The LSTM16D-T₂ calculates a similarity between the vector of the hidden state Hz at the decoder time T₂ and a weighting matrix for summary word generation that the RNN decoder has as a parameter of the model. Thus, for each word in the dictionary of the model, the degree that the word is to be generated as a word in the summary is scored. The calculating unit 17 normalizes the scores of each word in the dictionary of the model such that the total sum of the scores of the words is equal to “1”. Thus, the generation score of each word in the dictionary of the model is normalized to the generation probability of the word in the dictionary of the model. As a result, a vocabulary distribution D2 at the decoder time T₂ is acquired.

The attention distribution D1 and the vocabulary distribution D2 are linearly combined to acquire a final distribution D3 at the decoder time T₂. The loss calculating unit 18 then calculates a first loss between the final distribution D3 at the decoder time T₂ and the word “beat” in the correct answer summary at the decoder time T₂. The loss calculating unit 18 calculates a second loss between the NE category distribution at the decoder time T₂ calculated as of the decoder time T₁ and the NE label <B-COUNTRY> of the word in the correct answer summary at the decoder time T₂. The first loss and the second loss are used for updating the parameters of the model as losses at the decoder time T₂.

[Configuration of Generating Apparatus 30]

As illustrated in FIG. 1, the generating apparatus 30 includes an obtaining unit 31, a named entity extracting unit 35, an encoder executing unit 36E, a decoder executing unit 36D, a calculating unit 37, and a generating unit 38. In addition to the functional units illustrated in FIG. 1, the generating apparatus 30 may include various functional units that known computers usually include, such as various input devices and various audio output devices.

The functional units such as the obtaining unit 31, the named entity extracting unit 35, the encoder executing unit 36E, the decoder executing unit 36D, the calculating unit 37, and the generating unit 38 illustrated in FIG. 1 are given for illustration purpose and may be implemented virtually by the following hardware processor. Examples of such processors include a DLU, a GPGPU and a GPU cluster. Examples of the processors may further include a CPU and an MPU. In other words, for example, the processor expands the generating program as a process over a memory such as a RAM to virtually implement the aforementioned functional units. Although the DLU, the GPGPU, the GPU duster, the CPU and the MPU are exemplified as one example of the processor here, the functional units may be implemented by any processor regardless of whether the processor is a general-purpose type or a special type. In addition, the functional units described above may be implemented by a hard wired logic circuit such as an ASIC or FPGA.

The storage unit to be referred or registered by the functional units Illustrated in FIG. 1 may be a storage device such as an HDD, an optical disk and an SSD. The storage device may not be an auxiliary storage device but may be a semiconductor memory element such as a RAM, an EPPROM or a flash memory.

The obtaining unit 33 is a processing unit that obtains input text.

According to an embodiment, the obtaining unit 33 starts processing in response to reception of a request for summary generation. When the processing starts, the obtaining unit 33 obtains input text for which a summary is to be generated. The information source of the input text may be arbitrary. For example, the input text may be obtained from an internal storage in the generating apparatus 30, or the input text may be obtained from an external computer, not illustrated, such as a user terminal or a file server or from a removable medium or the like.

The named entity extracting unit 35 is a processing unit that extracts a named entity.

According to an embodiment, the named entity extracting unit 35 extracts a named entity from input text obtained by the obtaining unit 33 or a summary generated by the generating unit 38. For example, the named entity extracting unit 35 executes morphological analysis on input text or text of a summary. By using the result of the morphological analysis, the named entity extracting unit 35 executes labeling processing that gives an NE label corresponding to the position of the word for each word included in the input text or text in the summary, like the named entity extracting unit 15. This labeling processing may use an arbitrary engine for named entity extraction, that may be open-source software.

The encoder executing unit 36E is a processing unit that executes an RNN encoder.

According to an embodiment, the encoder executing unit 36E expands, over a work area, K LSTM cells corresponding to the number K of words in input text obtained by the obtaining unit 33 based on trained model information stored in the model storage unit 12. Thus, K LSTM cells are caused to function as an RNN encoder. Hereinafter, encoder times corresponding to word strings in input text are time-serially identified as t₁, t₂, t₃, . . . , t_{K}, and an LSTM cell corresponding to an encoder time tₖ is identified as “LSTM36E-tₖ”.

For example, sequentially from the word at the beginning of input text, the encoder executing unit 36E vectorizes the kth word from the beginning of a word string and the NE label given to the word and inputs the vector of the kth word and the vector of the NE label to the LSTM36E-tₖ. The encoder executing unit 36E inputs an output such as a hidden state at the encoder time tₖ₋₁ output from the LSTM36E-tₖ₋₁ to the LSTM36E-tₖ. The LSTM36E-tₖ having received the vector of the kth word, the vector of the NE label and the hidden state at the encoder time tₖ₋₁ adds the vector of the kth word and the vector of the NE label to the hidden state at the encoder time tₖ₋₁ to update the hidden state at the encoder time tₖ to a hidden state at the encoder time tₖ. Thus, the update of the hidden states, so-called context vectors are repeated from the LSTM cell corresponding to the word at the beginning of the input text to the LSTM cell corresponding to the Kth word at the end. The hidden states of the input text generated by the RNN encoder are input to the RNN decoder.

The decoder executing unit 36D is a processing unit that executes an RNN decoder.

According to an embodiment, the decoder executing unit 36D expands, over a work area, N LSTM cells until the tag for an end-of-sentence symbol is output based on trained model information stored in the model storage unit 12. Thus, the L LSTM cells expanded until the tag for the end-of-sentence symbol is output are caused to function as an RNN decoder. Hereinafter, decoder times corresponding to word strings in a summary output from the generating unit 38 are time-serially identified as T₁, T₂, T₃, . . . , T_{L}, and an LSTM cell corresponding to a decoder time Tₗ is identified as “LSTM36D-Tₗ”.

First, the decoder executing unit 360 vectorizes a beginning symbol of a word such as <START> and a beginning symbol of an NE label such as <NESTART>. The decoder executing unit 36D inputs the hidden state output from the LSTM36E-tₖ of the RNN encoder along with the vector of the beginning symbol of the word and the vector of the beginning symbol of the NE label to the LSTM36D-T₁ corresponding to the decoder time T₁. Thus, the LSTM36D-T₁ adds the vector of the beginning symbol of the word and the vector of the beginning symbol of the NE label to the hidden state output from the LSTM36E-tₖ so that the hidden state at the encoder time tₖ is updated to the hidden state at the decoder time T₁.

After that, the LSTM36D-T₁ calculates a similarity such as an inner product between the vector of the hidden state at the decoder time T₁ and vectors of the hidden states at the encoder times t₁ to t_{K}. Thus, for each word included in the input text, the degree that the word is to be copied as a word in the summary is scored. The LSTM36D-T₁ calculates a similarity such as an inner product between the vector of the hidden state at the decoder time T₁ and a weighting matrix for summary word generation that the RNN decoder has as a parameter of the model. Thus, for each word in the dictionary of the model, the degree that the word is to be generated as a word in the summary is scored. The LSTM36D-T₁ calculates a similarity such as an inner product between the vector of the hidden state at the decoder time T₁ and a weighting matrix for NE label generation that the RNN decoder has as a parameter of the model. Thus, for each category of the NE label, the degree that the category is to be selected at the next decoder time T₂ is scored. The hidden state at the decoder time T₁ updated by the LSTM36D-T₁ is used for calculation of the three scores and is also input to the LSTM36D-T₂.

Also for the subsequent LSTM cells, that is, the LSTM36D-T₂ to the LSTM36D-T_{L}, the hidden state update and the calculation of the three scores are performed in the same manner as those for the LSTM36D-T₁.

In other words, for example, the decoder executing unit 36D vectorizes a word in the summary generated at a decoder time Tᵢ₋₁ and an NE label at a decoder time Tₗ selected at the decoder time Tₗ₋₁. Along with the vector of the word in the summary at the decoder time Tₗ₋₁ and the vector of the NE label at the decoder time Tₗ, the decoder executing unit 360 inputs the hidden state at the decoder time Tₗ₋₁ to the LSTM36D-Tₗ. After that, the LSTM36D-Tₗ adds the vector of the word in the summary at the decoder time Tₗ₋₁ and the vector of the NE label at the decoder time T to the hidden state at the decoder time Tₗ₋₁. Thus, the hidden state at the decoder time Tₗ₋₁ is updated to the hidden state at the decoder time Tₗ₋₁.

After that, the LSTM36D-Tₗ calculates a similarity between the vector of the hidden state at the decoder time Tₗ and vectors of the hidden states at the encoder times t₁ to t_{K}. Thus, for each word included in the input text, the degree that the word is to be copied as a word in the summary is scored. The LSTM36D-Tₗ calculates a similarity between the vector of the hidden state at the decoder time Tₗ and a weighting matrix for summary word generation that the RNN decoder has as a parameter of the model. Thus, for each word in the dictionary of the model, the degree that the word is to be generated as a word in the summary is scored. The LSTM36D-Tₗ calculates a similarity between the vector of the hidden state at the decoder time Tₗ and a weighting matrix for NE label generation that the RNN decoder has as a parameter of the model. Thus, for each category of the NE label, the degree that the category is to be selected at the next decoder time Tₗ₊₁ is scored. The hidden state at the decoder time Tₗ updated by the LSTM36D-Tₗ is used for calculation of the three scores and is also input to the LSTM36D-Tₗ₊₁.

By operating L LSTM cells, scores for words in the input text and scores for words in the dictionary of the model are acquired for a set of L LSTM cells.

The calculating unit 37 is a processing unit that calculates a probability distribution.

According to one aspect, when, for each word included in input text, the LSTM36D-Tₗ scores the degree that the word is to be copied as a word in a summary, the calculating unit 37 normalizes the score of the word such that the total sum of the scores of the word is equal to “1”. Thus, the copy score of each word in the input text is normalized to the copy probability of the word in the input text. As a result, an attention distribution at the decoder time Tₗ is acquired.

According to another aspect, when, for each word in the dictionary of the model, the LSTM36D-Tₗ scores the degree that the word is to be generated as a word in a summary, the calculating unit 37 normalizes the score of the word such that the total sum of the scores of the word is equal to “1”. Thus, the generation score of each word in the dictionary of the model is normalized to the generation probability of the word in the dictionary of the model. As a result, a vocabulary distribution at the decoder time Tₗ is acquired.

The thus acquired attention distribution and vocabulary distribution are linearly combined. For example, for a word commonly existing in both of the attention distribution and the vocabulary distribution, the copy probability and the generation probability are added to acquire a composite probability. For a word existing in one distribution of the attention distribution and the vocabulary distribution, the other copy probability or generation probability is defined as zero, and one copy probability or generation probability is added thereto to acquire a composite probability. Then, the composite probabilities of the words are normalized such that the total sum of the composite probabilities of the words in the input text and in the dictionary of the model is equal to “1”. Thus, a final distribution at the decoder time Tₗ is acquired.

According to another aspect, when, for each category of an NE label, the LSTM36D-Tₗ scores the degree that the category is to be selected at the decoder time Tₗ₊₁, the calculating unit 37 normalizes scores of the categories such that the total sum of the categories of the NE labels is equal to “1”. Thus, the selection scores of the categories of the NE labels are normalized to selection probabilities of the categories of the NE labels. As a result, an NE category distribution at the decoder time Tₗ₊₁ is acquired.

The generating unit 38 is a processing unit that generates a word of a summary.

According to an aspect, when the final distribution at the decoder time T is calculated by the calculating unit 37, the generating unit 38 performs processing as follows. That is, the generating unit 38 generates a word having a maximum composite probability of composite probabilities included in the final distribution at the decoder time Tₗ as a word in the summary at the decoder time Tₗ or the lth word from the beginning of the summary.

According to another aspect, when the NE category distribution at the decoder time Tₗ₊₁ is calculated, the generating unit 38 performs processing as follows. That is, the generating unit 38 selects the category of the NE label having a maximum selection probability of selection probabilities included in the NE category distribution at the decoder time Tₗ₊₁ as an NE label at the decoder time Tₗ₊₁.

[Specific Example of Summary Generation]

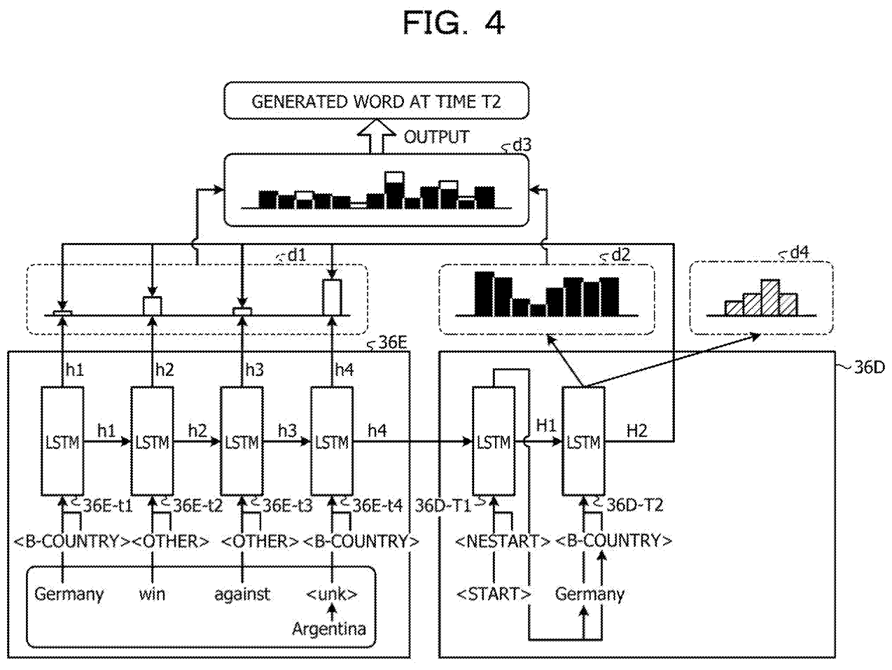

FIG. 4 is a diagram illustrating an example of summary generation. For convenience of description, FIG. 4 illustrates an example of a case where “Germany win against Argentina” is acquired as an example of input text. In this case, as illustrated in FIG. 4, the encoder executing unit 36E expands, over a work area, four LSTM36E-t₁ to LSTM36E-t₄ corresponding to the number “4” of words of the input text.

(1.1) Operations at Encoder Time t₁

The encoder executing unit 36E vectorizes the word “Germany” at the beginning of input text and vectorizes the NE label <B-COUNTRY> given to the word “Germany”. Along with the vector of the word “Germany” at the beginning and the vector of the NE label <B-COUNTRY>, the encoder executing unit 36E inputs an initial value h₀ of the vector of a hidden state to the LSTM36E-t₁. The LSTM36E-t₁ adds the vector of the word “Germany” at the beginning and the vector of the NE label <B-COUNTRY> to the vector of the hidden state h₀ being the initial value so that the hidden state h₀ being the initial value is updated to a hidden state h₁ at an encoder time t₁. The updated hidden state h₁ at the encoder time t₁, is input from the LSTM36E-t₁ to an LSTM36E-t₂.

(1.2) Operations at Encoder Time t₂

The encoder executing unit 36E vectorizes the second word “win” from the beginning of the input text and vectorizes the NE label <OTHER> given to the word “win”. The encoder executing unit 36E inputs the vector of the second word “win” and the vector of the NE label <OTHER> to the LSTM36E-t₂. The LSTM36E-t₂ adds the vector of the second word “win” and the vector of the NE label <OTHER> to the vector of the hidden state h₁ at the encoder time t₁ so that the hidden state h₁ at the encoder time t₁ is updated to a hidden state h₂ at an encoder time t₂. The updated hidden state h₂ at the encoder time t₂ is input from the LSTM36E-t₂ to an LSTM36E-t₃.

(1.3) Operations at Encoder Time t₃

The encoder executing unit 36E vectorizes the third word “against” from the beginning of the input text and vectorizes the NE label <OTHER> given to the word “against”. The encoder executing unit 36E inputs the vector of the third word “against” and the vector of the NE label <OTHER> to the LSTM36E-t₃. The LSTM36E-t₃ adds the vector of the third word “against” and the vector of the NE label <OTHER> to the vector of the hidden state h₂ at the encoder time t₂ so that the hidden state h₂ at the encoder time t₂ is updated to a hidden state h₃ at an encoder time t₃. The updated hidden state h₃ at the encoder time b is input from the LSTM36E-tₐ to an LSTM36E-t₄.

(1.4) Operations at Encoder Time t₄

Finally, the encoder executing unit 36E vectorizes the fourth word “Argentina” from the beginning of the input text and vectorizes the NE label <OTHER> given to the word “Argentina”. The encoder executing unit 36E inputs the vector of the fourth word “Argentina” and the vector of the NE label <OTHER> to the LSTM36E-t₄. The LSTM36E-t₄ adds the vector of the fourth word “Argentina” and the vector of the NE label <OTHER> to the vector of the hidden state h₃ at the encoder time b so that the hidden state h₃ at the encoder time t₃ is updated to a hidden state h₄ at an encoder time t₄. The updated hidden state h₄ at the encoder time t₄ is input from the RNN encoder to the RNN decoder.

In this way, from the LSTM36E-t₁ at the beginning to LSTM36E-t₄ at the end, the hidden state, so-called the context vector is repeatedly updated in order of h₀, h₁, h₂, h₃, and h₄.

(2) Operations at Decoder Time T₃

FIG. 4 illustrates an operation example by the LSTM36D-T₂ at the decoder time T₂. As illustrated in FIG. 4, a hidden state H₁ at the decoder time T₁ that is updated from the hidden state h₄ at the encoder time t₄ by the LSTM36D-T₁ is input to the LSTM36D-T₂. The vector of the word “Germany” in the summary generated at the decoder time T₁ and the vector of the NE label <B-COUNTRY> at the decoder time T₂ selected at the decoder time T₁ are input to the LSTM36D-T₂. After that, the LSTM36D-T₂ adds the vector of the word “Germany” in the summary at the decoder time T₁ and the vector of the NE label <B-COUNTRY> at the decoder time T₂ to the hidden state H₁ at the decoder time T₁. Thus, the hidden state H₁ at the decoder time T₁ is updated to a hidden state H₂ at the decoder time T₂.

After that, the LSTM36D-T₂ calculates a similarity between the vector of the hidden state H₂ at the decoder time T₂ and vectors of the hidden states h₁ to h₄ at the encoder times t₁ to t₄. Thus, for each word included in the input text, the degree that the word is to be copied as a word in the summary is scored. The calculating unit 37 then normalizes the scores of each word in the input text such that the total sum of the scores of the words is equal to “1”. Thus, the copy score of each word in the input text is normalized to the copy probability. As a result, an attention distribution d1 at the decoder time T₂ is acquired.

The LSTM36D-T₂ calculates a similarity between the vector of the hidden state H₂ at the decoder time T₂ and a weighting matrix for summary word generation that the RNN decoder has as a parameter of the model. Thus, for each word in the dictionary of the model, the degree that the word is to be generated as a word in the summary is scored. The calculating unit 37 then normalizes the scores of each word in the dictionary of the model such that the total sum of the scores of the words is equal to “1”. Thus, the generation score of each word in the dictionary of the model is normalized to the generation probability. As a result, a vocabulary distribution d2 at the decoder time T₂ is acquired.

The attention distribution d1 and the vocabulary distribution d2 are linearly combined to acquire a final distribution d3 at the decoder time T₂. After that, the generating unit 38 generates a word “beat” having a maximum composite probability of composite probabilities included in the final distribution D3 at the decoder time T₂ as a word in the summary at the decoder time T₂.

The LSTM36D-T₂ calculates a similarity between the vector of the hidden state Hz at the decoder time T₂ and a weighting matrix for NE label generation that the RNN decoder has as a parameter of the model. Thus, for each category of the NE label, the degree that the category is to be selected at the next decoder time T₃ is scored. The calculating unit 37 then normalizes the scores of each category such that the total sum of the scores of the categories of the NE labels is equal to “1”. Thus, the selection scores of the categories of the NE labels are normalized to selection probabilities. As a result, an NE category distribution d4 at the decoder time T₃ is acquired.

After that, the generating unit 38 selects the category having a maximum selection probability of selection probabilities included in the NE category distribution d4 at the decoder time T₃ as an NE label at the decoder time T₃. In this way, the NE label at the decoder time T₃ selected as of the decoder time T₂ is used for updating the hidden state H₂ as of the decoder time T₃. As of the decoder time T₃, an attention distribution and a vocabulary distribution and, by extension, a final distribution may be calculated based on which named entity or other word is easier to output, if a named entity is easier to output, which category of the named entity is easier to output, and whether the named entity that is easier to output next is at the beginning or another position.

[Comparison Between Cases of Generation of Summary]

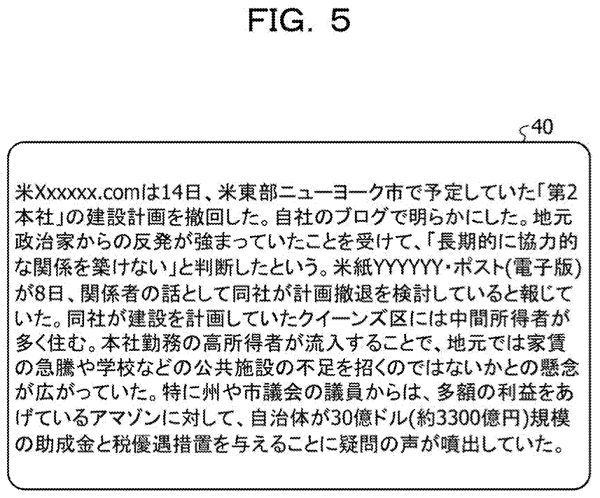

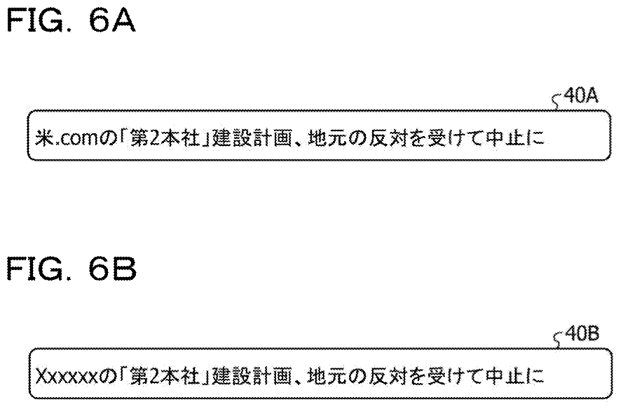

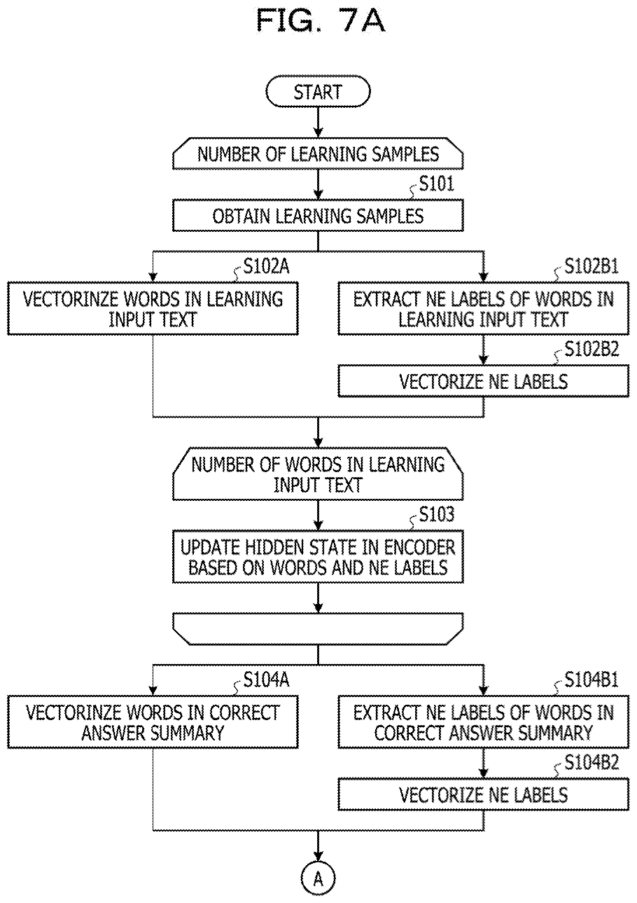

Cases of generation of a summary in a technology in the past and in this embodiment will be compared with reference to FIGS. 5 and 6.

FIG. 5 is a diagram illustrating an example of input text. Both of FIGS. 6A and 68 are diagrams illustrating examples of a summary. Between them, FIG. 6A illustrates a case of generation of a summary according to a technology in the past while FIG. 6B illustrates a case of generation of a summary according to Embodiment 1. Note that each examples illustrated in FIGS. 5, 6A, and 6 is written in Japanese language. The words of “ [symbol] Xxxxxx.com” mean a U.S. company named “Xxxxxx.com”. In this case, the Chinese character of “ [symbol] ” in Japanese stands for United States of America.

For example, when input text 40 illustrated in FIG. 5 is input to a model of Pointer-Generator according to a technology in the past, a summary 40A Illustrated in FIG. 6A is generated. As Illustrated in FIG. 6A, in the summary 40A, words “.” and “com” in the middle of the named entity of the named entity phrase “Xxxxxx.com” in the input text 40 illustrated in FIG. 5 are copied. In the summary 40A, the word “ [symbol] ” that is not a named entity is copied from the input text 40 as a word in the summary. As a result, from the summary 40A, the original named entity “Xxxxxx.com” present in the input text 40 may not be recognized, and a compound noun “ [symbol] .com” having a meaning changed from the meaning of the original named entity is generated. In this way, as in the technology in the past, with Pointer-Generator, a summary that is unnatural to humans may be generated.

On the other hand, when the input text 40 illustrated in FIG. 5 is input to a model of Pointer-Generator according to Embodiment 1, a summary 40B illustrated in FIG. 68 is generated. In this case, in order to generate a word at the beginning of the summary 40B, the NE label <B-COUNTRY> is added to the hidden state output from the encoder. Thus, an attention distribution and a vocabulary distribution and, by extension, a final distribution are calculated based on the updated hidden state. As a result, as illustrated in FIG. 6B, in the summary 40B, the word “Xxxxx” at the beginning of the named entity may be generated, and copying only the words “.” and “com” in the middle of the named entity may be suppressed. Therefore, the unknown word may be included in a proper expression in a summary.

(1) Learning Processing

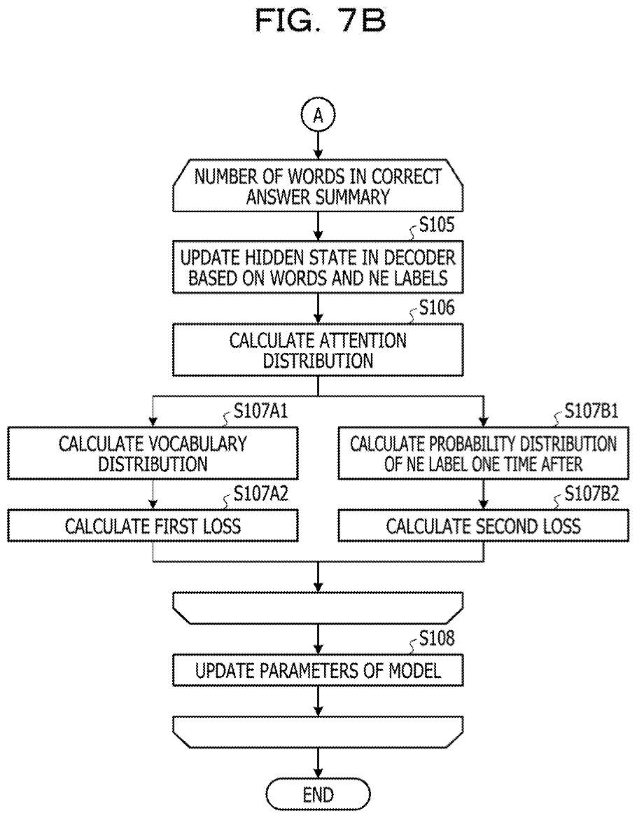

FIG. 7 (i.e., FIGS. 7A and 7B) is a flowchart illustrating the steps of learning processing according to Embodiment 1. As an example, this learning processing is started in response to reception of a request for model learning. As illustrated in FIG. 7, the obtaining unit 13 executes processing from step S101 below to step S108 below for a set of J learning samples j included in learning data.

That is, the obtaining unit 13 obtains one learning sample j of learning data stored in the learning data storage unit 11 (step S101). For each word included in the learning input text included in the learning sample obtained in step S101, the encoder executing unit 16E vectorizes the word (step S102A).

At the same time as or before or after the processing in step S102A, step S102B1 and step S102B2 may be executed. That is, in step S10281, the named entity extracting unit 15 gives an NE label to each word included in the learning input text. Next, in step S102B2, the encoder executing unit 16E vectorizes the NE label of each word in the learning input text.

After that, processing in step S103 below is executed on M words included in the learning input text, that is, every decoder time tₘ from an encoder time t₁ to an encoder time t_{M}. In other words, for example, the encoder executing unit 16E inputs the hidden state at the encoder time tₘ₋₁ and the vector of the mth word from the beginning of the learning input text and the vector of the NE label to the LSTM16E-tₘ. The LSTM16E-tₘ having received the inputs updates the hidden state at the encoder time tₘ₋₁ to the hidden state at the encoder time tₘ (step S103).

Thus, the update of the hidden states, so-called context vectors are repeated from the LSTM cell corresponding to the word at the beginning of the learning input text to the LSTM cell corresponding to the Mth word at the end.

After that, for each word included in the text of the correct answer summary included in the learning sample obtained in step S101, the decoder executing unit 16D vectorizes the word (step S104A).

At the same time as or before or after the processing in step S104A, step S10481 and step S104B2 may be executed. That is, in step S10481, the named entity extracting unit 15 gives an NE label to each word included in the correct answer summary. Next, in step S104B2, the decoder executing unit 16D vectorizes the NE label of each word in the correct answer summary.

After that, processing from step S105 below to step S107 below is executed on N words included in the correct answer summary, that is, every decoder time Tₙ from a decoder time T₁ to a decoder time T_{N}.

That is, along with the vector of the word in the correct answer summary at the decoder time Tₙ₋₁ and the vector of the NE label at the decoder time Tₙ, the decoder executing unit 160 inputs the hidden state at the decoder time Tₙ₋₁ to the LSTM16D-Tₙ. The LSTM16D-Tₙ having received the inputs updates the hidden state at the decoder time Tₙ₋₁ to the hidden state at the decoder time Tₙ (step S105).

Next, by normalizing the score acquired by scoring the similarity between the vector of the hidden state at the decoder time Tₙ and the vectors at hidden states at the encoder times t₁ to t_{M} by the LSTM16D-Tₙ for each word in the learning input text, the calculating unit 17 calculates an attention distribution at the decoder time Tₙ (step S106).

By normalizing the score acquired by scoring the similarity between the vector of the hidden state at the decoder time Tₙ and a weighting matrix for summary word generation by the LSTM16D-Tₙ for each word in the dictionary of the model, the calculating unit 17 calculates a vocabulary distribution at the decoder time Tₙ (step S107A1). Next, the loss calculating unit 18 calculates a first loss between a final distribution at the decoder time Tₙ acquired from the attention distribution calculated in step S106 and the vocabulary distribution calculated in step S107A1 and the word in the correct answer summary at the decoder time Tₙ (step S107A2).

At the same time as or before or after the processing in step S107A1 and step S107A2, step S107B1 and step S107B2 may be executed. That is, in step S107B1, by normalizing the score acquired by scoring the similarity between the vector of the hidden state at the decoder time Tₙ and a weighting matrix for NE label generation by the LSTM16D-Tₙ for each category of the NE label, the calculating unit 17 calculates an NE category distribution at the decoder time Tₙ₊₁. Next, in step S107B2, the loss calculating unit 18 calculates a second loss between the NE category distribution at the decoder time Tₙ calculated as of the decoder time Tₙ₋₁ and the NE label of the word in the correct answer summary at the decoder time Tₙ.

When the first loss and the second loss are calculated for each set of N words in the correct answer summary, the updating unit 19 executes log-likelihood optimization based on the first losses and the second losses at the decoder times T₁ to T_{N} so that parameters to update the model of the RNN are calculated, and the parameters in the model stored in the model storage unit 12 are updated (step S108).

Then, after the parameters of the model are updated for all of the learning samples j included in the learning data, the processing is ended.

(2) Generation Processing

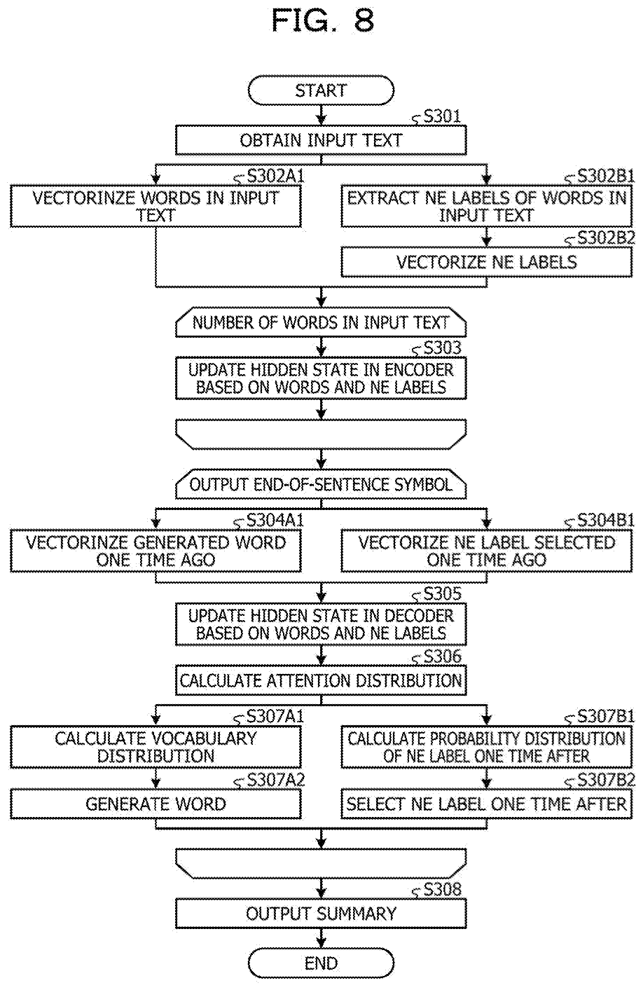

FIG. 8 is a flowchart illustrating the steps of generation processing according to Embodiment 1. As an example, this generation processing is started in response to reception of a request for summary generation. As illustrated in FIG. 8, the obtaining unit 33 obtains input text from an arbitrary input source (step S301).

Next, for each word included in the input text obtained in step S301, the encoder executing unit 36E vectorizes the word (step S302A1).

At the same time as or before or after the processing in step S302A1, step S302B1 and step S302B2 may be executed. That is, in step S302B1, the named entity extracting unit 35 gives an NE label to each word included in the input text. Next, in step S302B2, the encoder executing unit 36E vectorizes the NE label of each word in the input text.

After that, processing in step S303 below is executed on K words included in the input text, that is, every decoder time tₖ from the encoder time t₁ to an encoder time t_{K}. In other words, for example, the encoder executing unit 36E inputs the hidden state at the encoder time tₖ₋₁ and the vector of the kth word from the beginning of the input text and the vector of the NE label to the LSTM36E-tₖ. The LSTM36E-tₖ having received the inputs updates the hidden state at the encoder time tₖ₋₁ to the hidden state at the encoder time tₖ (step S303).

Thus, the update of the hidden states, so-called context vectors are repeated from the LSTM cell corresponding to the word at the beginning of the input text to the LSTM cell corresponding to the Kth word at the end.

After that, until the tag for the end-of-sentence symbol is output, every decoder time Tₗ corresponding to a word string in a summary output from the generating unit 38, processing from step S304 below to step S307 below is executed.

That is, the decoder executing unit 36D vectorizes the word in the summary generated at the decoder time Tₗ₋₁ one before the decoder time Tₗ (step S304A1).

At the same time as or before or after the processing in step S304A1, step S304B1 may be executed. That is, in step S304B1, the decoder executing unit 36D vectorizes the NE label at the decoder time Tₗ selected at the one previous decoder time Tₗ₋₁.

After that, along with the vector of the word in the summary at the decoder time Tₗ₋₁ and the vector of the NE label at the decoder time Tₗ, the decoder executing unit 36D inputs the hidden state at the decoder time Tₗ₋₁ to the LSTM36D-Tₗ. The LSTM36D-Tₗ having received the inputs updates the hidden state at the decoder time Tₗ₋₁ to the hidden state at the decoder time Tₗ (step S305).

Next, by normalizing the score acquired by scoring the similarity between the vector of the hidden state at the decoder time Tₗ and the vectors at hidden states at the encoder times t₁ to t_{K} by the LSTM36D-Tₗ for each word in the input text, the calculating unit 37 calculates an attention distribution at the decoder time Tₗ (step S306).

By normalizing the score acquired by scoring the similarity between the vector of the hidden state at the decoder time T and a weighting matrix for summary word generation by the LSTM36D-Tₗ for each word in the dictionary of the model, the calculating unit 37 calculates a vocabulary distribution at the decoder time Tₗ (step S307A1). Next, the generating unit 38 generates a word having a maximum composite probability of composite probabilities included in the final distribution at the decoder time Tₗ acquired from the attention distribution calculated in step S306 and the vocabulary distribution calculated in step S307A1 as a word in the summary at the decoder time Tₗ (step S307A2).

At the same time as or before or after the processing in step S307A1 and step S307A2, step S307B1 and step S307B2 may be executed. That is, in step S307B1, by normalizing the score acquired by scoring the similarity between the vector of the hidden state at the decoder time Tₗ and a weighting matrix for NE label generation by the LSTM36D-Tₗ for each category of the NE label, the calculating unit 37 calculates an NE category distribution at the decoder time Tₗ₊₁. Next, in step S307B2, the generating unit 38 selects the category of the NE label having a maximum selection probability of selection probabilities included in the NE category distribution at the decoder time Tₗ₊₁ as an NE label at the decoder time Tₗ₊₁.

After that, when a tag for an end-of-sentence symbol is output from the RNN decoder, the generating unit 38 joins words generated from the first LSTM cell to the Lth LSTM cell to generate a summary and outputs the generated summary to a predetermined output destination (step S308), and the processing is ended.

[One Aspect of Effects]

As described above, in the generating apparatus 30 according to this embodiment, a hidden state repeatedly updated with words of input text and labels of named entities is input to a decoder, and the decoder updates the hidden state with a word one time ago and labels of named entities, calculates an attention distribution and a vocabulary distribution, and outputs words of a summary. Therefore, with the generating apparatus 30 according to this embodiment, unknown words may be included in a proper expression in a summary.

In the learning apparatus 10 according to this embodiment, a hidden state repeatedly updated with words of learning input text and labels of named entities is input to a decoder, and the decoder updates the hidden state with a word one time ago and labels of named entities, calculates an attention distribution and a vocabulary distribution, and updates the parameters of the model. Therefore, with the generating apparatus 30 according to this embodiment, model learning may be implemented in which unknown words is included in a proper expression in a summary.

### Embodiment 2

The embodiments of the apparatus of the present disclosure have been described. It is to be understood that embodiments may be made in various ways other than the aforementioned embodiments. Therefore, other embodiments are described below.

[Distribution and Integration]

The components illustrated in the drawings do not necessarily have to be physically configured as illustrated in the drawings. Specific forms of the separation and integration of the devices are not limited to the illustrated forms, and all or a portion thereof may be separated and integrated in any units in either a functional or physical manner depending on various loads, usage states, and the like. For example, the obtaining unit 13, the named entity extracting unit 15, the encoder executing unit 16E, the decoder executing unit 16D, the calculating unit 17, the loss calculating unit 18 or the updating unit 19 may be coupled with the learning apparatus 10 over a network as external devices. Alternatively, the obtaining unit 31, the named entity extracting unit 35, the encoder executing unit 36E, the decoder executing unit 36D, the calculating unit 37 or the generating unit 38 may be coupled with the generating apparatus 30 over a network as external devices. The obtaining unit 13, the named entity extracting unit 15, the encoder executing unit 16E, the decoder executing unit 16D, the calculating unit 17, the loss calculating unit 18 or the updating unit 19 may be provided in separate apparatuses and may be coupled over a network for cooperation to implement the functions of the learning apparatus 10. Alternatively, the obtaining unit 31, the named entity extracting unit 35, the encoder executing unit 36E, the decoder executing unit 36D, the calculating unit 37, or the generating unit 38 may be provided in separate apparatuses and may be coupled over a network for cooperation to implement the functions of the generating apparatus 30.

[Generating Program]

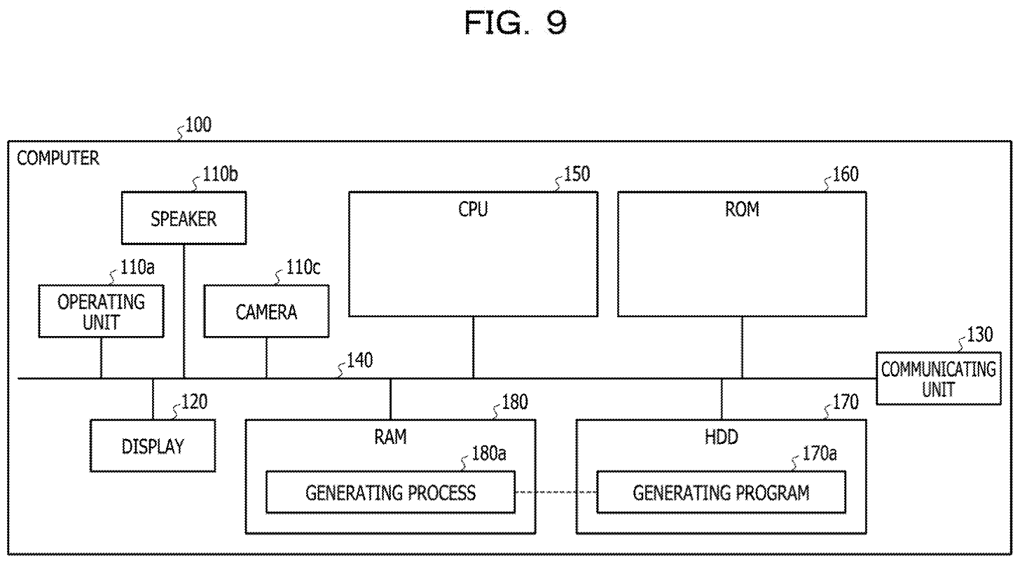

The various kinds of processing described in the above embodiments may be implemented by executing a program prepared in advance on a computer such as a personal computer or a work station. In the following, with reference to FIG. 9, a description is given of an example of a computer for executing a generating program having the same functions as those of the above-described embodiments.

FIG. 9 is a diagram illustrating a hardware configuration example of a computer. As illustrated in FIG. 9, a computer 100 includes an operation unit 110a, a speaker 110b, a camera 110c, a display 120, and a communication unit 130. The computer 100 includes a CPU 150, a read-only memory (ROM) 160, an HDD 170, and a RAM 180. These units 110 to 180 are coupled to each other via a bus 140.

The HDD 170 stores a generating program 170a that implements equivalent functions to the obtaining unit 31, the named entity extracting unit 35, the encoder executing unit 36E, the decoder executing unit 36D, the calculating unit 37 and the generating unit 38 according to Embodiment 1, as illustrated in FIG. 9. The generating program 170a may be integrated or separated, like the components of the obtaining unit 31, the named entity extracting unit 35, the encoder executing unit 36E, the decoder executing unit 36D, the calculating unit 37 or the generating unit 38 illustrated in FIG. 1. In other words, for example, the HDD 170 may not store all data described according to Embodiment 1, but data to be used for processing may be stored in the HDD 170. Having exemplarily described the example in which the generating program 170a is stored in the HDD 170, a learning program that implements equivalent functions to the obtaining unit 13, the named entity extracting unit 15, the encoder executing unit 16E, the decoder executing unit 16D, the calculating unit 17, the loss calculating unit 18 and the updating unit 19 may be stored therein.

Under such an environment, the CPU 150 loads the generating program 170a from the HDD 170 into the RAM 180. As a result, the generating program 170a functions as a generating process 180a as illustrated in FIG. 9. The generating process 180a unarchives various kinds of data read from the HDD 170 in an area allocated to the generating process 180a in the storage area included in the RAM 180, and executes various kinds of processing using these various kinds of data thus unarchived. For example, the processing performed by the generating process 180a includes the processing illustrated in FIG. 8 as an example. Not all the processing units described in Embodiment 1 necessarily have to operate on the CPU 150, but only a processing unit(s) required for the processing to be executed may be virtually implemented.

The generating program 170a does not necessarily have to be initially stored in the HDD 170 or the ROM 160. For example, the generating program 170a is stored in a “portable physical medium” such as a flexible disk called an FD, a CD-ROM, a DVD disk, a magneto-optical disk, or an IC card, which will be inserted into the computer 100. The computer 100 may acquire the generating program 170a from the portable physical medium, and execute the generating program 170a. The generating program 170a may be stored in another computer or server apparatus coupled to the computer 100 via a public line, the Internet, a LAN, a WAN, or the like, and the computer 100 may acquire the generating program 170a from the other computer and execute the generating program 170a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A generating method implemented by a computer, the method comprising:
executing an obtaining processing that includes obtaining input text;
executing a first calculating processing that includes calculating, for each encoder time corresponding to a word string in the input text, a hidden state at the encoder time from a hidden state at one previous encoder time based on a word in the input text and a label of a named entity corresponding to the encoder time;
executing an input processing that includes inputting the hidden state output from the encoder to a decoder;
executing a second calculating processing that includes calculating, for each decoder time corresponding to the word string in a summary output from the decoder, a hidden state at the decoder time from a hidden state at one previous decoder time based on the word and label of the named entity in the summary generated at the one previous decoder time;
executing a third calculating processing that includes calculating a first probability distribution based on the hidden state at the decoder time and the hidden state at the encoder time, the first probability distribution being a probability distribution in which each of words in the word string in the input text is to be copied as a word in the summary at the decoder time;
executing a fourth calculating processing that includes calculating a second probability distribution based on the hidden state at the decoder time, the second probability distribution being a probability distribution in which each of words in a dictionary of a model including the encoder and the decoder is to be generated as a word in the summary at the decoder time; and
executing a generating processing that includes generating words in the summary at the decoder time based on the first probability distribution and the second probability distribution.

2. The generating method according to claim 1, further comprising:
calculating a third probability distribution that each label of a named entity is to be selected at a decoder time next to the decoder time based on the hidden state at the decoder time; and
selecting a label of a named entity at the decoder time based on the third probability distribution calculated at the one previous decoder time,
wherein the hidden state at the decoder time is calculated based on the label of the named entity selected at the one previous decoder time.

3. A learning method implemented by a computer, the method comprising:
obtaining learning input text and a correct answer summary;
for each encoder time corresponding to a word string in the learning input text, calculating a hidden state at the encoder time from a hidden state at one previous encoder time based on a word in the learning input text and a label of a named entity corresponding to the encoder time;
inputting the hidden state output from the encoder to a decoder;
for each decoder time corresponding to a word string in the correct answer summary, calculating a hidden state at the decoder time from a hidden state at one previous decoder time based on a word in the correct answer summary and a label of a named entity corresponding to the decoder time;
calculating a first probability distribution based on the hidden state at the decoder time and the hidden state at the encoder time, the first probability distribution being a probability distribution in which each of words in the word string in the learning input text is to be copied as a word in the summary at the decoder time;
calculating a second probability distribution based on the hidden state at the decoder time, the second probability distribution being a probability distribution in which each of words in a dictionary of a model including the encoder and the decoder is to be generated as a word in the summary at the decoder time and a third probability distribution that each of labels of named entities is to be selected at a decoder time next to the decoder time;
calculating a first loss between the first probability distribution and the second probability distribution and the word in the correct answer summary at the decoder time and calculating a second loss between the third probability distribution at the decoder time calculated at the one previous decoder time and the label of the named entity of the word in the correct answer summary at the decoder time; and
updating the parameters of the model based on the first loss and the second loss.

4. A non-transitory computer-readable storage medium for storing a generating program which causes a processor to perform processing, the processing comprising:
executing an obtaining processing that includes obtaining input text;
executing a first calculating processing that includes calculating, for each encoder time corresponding to a word string in the input text, a hidden state at the encoder time from a hidden state at one previous encoder time based on a word in the input text and a label of a named entity corresponding to the encoder time;
executing an input processing that includes inputting the hidden state output from the encoder to a decoder;
executing a second calculating processing that includes calculating, for each decoder time corresponding to the word string in a summary output from the decoder, a hidden state at the decoder time from a hidden state at one previous decoder time based on the word and label of the named entity in the summary generated at the one previous decoder time;
executing a third calculating processing that includes calculating a first probability distribution based on the hidden state at the decoder time and the hidden state at the encoder time, the first probability distribution being a probability distribution in which each of words in the word string in the input text is to be copied as a word in the summary at the decoder time;
executing a fourth calculating processing that includes calculating a second probability distribution based on the hidden state at the decoder time, the second probability distribution being a probability distribution in which each of words in a dictionary of a model including the encoder and the decoder is to be generated as a word in the summary at the decoder time; and
executing a generating processing that includes generating words in the summary at the decoder time based on the first probability distribution and the second probability distribution.

5. A generating apparatus comprising:
a memory; and
a processor coupled to the memory, the processor being configured to
execute an obtaining processing that includes obtaining input text,
execute a first calculating processing that includes calculating, for each encoder time corresponding to a word string in the input text, a hidden state at the encoder time from a hidden state at one previous encoder time based on a word in the input text and a label of a named entity corresponding to the encoder time,
execute an input processing that includes inputting the hidden state output from the encoder to a decoder,
execute a second calculating processing that includes calculating, for each decoder time corresponding to the word string in a summary output from the decoder, a hidden state at the decoder time from a hidden state at one previous decoder time based on the word and label of the named entity in the summary generated at the one previous decoder time,
execute a third calculating processing that includes calculating a first probability distribution based on the hidden state at the decoder time and the hidden state at the encoder time, the first probability distribution being a probability distribution in which each of words in the word string in the input text is to be copied as a word in the summary at the decoder time,
execute a fourth calculating processing that includes calculating a second probability distribution based on the hidden state at the decoder time, the second probability distribution being a probability distribution in which each of words in a dictionary of a model including the encoder and the decoder is to be generated as a word in the summary at the decoder time, and
execute a generating processing that includes generating words in the summary at the decoder time based on the first probability distribution and the second probability distribution.
